(19) United States
(12) Patent Application Publication
(10) Pub. No.: US 2012/0306185 A1
(43) Pub. Date: Dec. 6, 2012

(54) AIR BELT APPARATUS FOR VEHICLE

(75) Inventors: Il Hwan Kim, Ansan-si (KR); Hyeong Ho Choi, Gwangmyeong-si (KR); Chang Ky Kang, Suwon-si (KR)

(73) Assignee: Hyundai Motor Company, Seoul (KR)

(21) Appl. No.: 13/270,081

(22) Filed: Oct. 10, 2011

(30) Foreign Application Priority Data
Jun. 3, 2011 (KR) 10-2011-0053641

(51) Int. Cl. B60R 21/18

(52) U.S. Cl. 280/733

(57) ABSTRACT

An air belt apparatus for a vehicle may include a seat belt passing through a belt hook mounted to a vehicle body and through a buckle tongue, with a first end of the seat belt being coupled to a belt retractor mounted to the vehicle body in such a way that the seat belt may be released from or retracted into the belt retractor, and with a second end of the seat belt being fixed to the vehicle body, and an airbag cushion which covers the seat belt and may be mounted at one end thereof to the buckle tongue, wherein the seat belt may be slidably mounted to the airbag cushion such that the airbag cushion does not move along with the seat belt, wherein the airbag cushion may be fluid-connected to the buckle tongue and receives airbag gas through the buckle tongue.

### CROSS-REFERENCE TO RELATED APPLICATIONS

The present application claims priority to Korean Patent Application No. 10-2011-0053641 filed on Jun. 3, 2011, the entire contents of which is incorporated herein for purposes by this reference.

### BACKGROUND OF THE INVENTION

1. Field of the Invention

The present invention relates, in general, to an air belt apparatus for a vehicle and, more particularly, to an air belt apparatus for a vehicle, which can realize a reduction in the weight and production cost of the air belt apparatus by reducing the number of parts of a retractor of the air belt apparatus.

2. Description of Related Art

Generally, a vehicle is equipped with a seat belt for holding and protecting the upper body of a passenger sitting in a seat in the event of a head-on collision or a rear collision of the vehicle.

However, the seat belt may strongly compress the chest of the passenger and may injure the passenger. In an effort to solve the problem, an air belt apparatus having an airbag cushion in the seat belt has been proposed and used.

As shown in FIG. 1 through FIG. 3, a conventional air belt apparatus includes a shoulder belt 4, which passes through a belt hook 1 mounted to a center pillar trim and of which a first end is coupled to the buckle tongue 2 and a second end is coupled to a shoulder belt retractor 3 so that the shoulder belt 4 can hold and protect the shoulder and chest of a passenger sitting in a seat. The air belt apparatus further includes a lap belt 6, of which a first end is coupled to the buckle tongue 2 and a second end is coupled to a lap belt retractor 5 so that the lap belt 6 can hold and protect the pelvic region and the lower body of the passenger. The air belt apparatus further includes an airbag cushion 7 provided in the shoulder belt 4, an inflator 8 for generating airbag gas, an airbag control unit 9 for controlling the operation of the inflator 8, and an airbag control unit (ACU).

Here, a first end of the airbag cushion 7 passes through the shoulder belt 4 and is connected to the buckle tongue 2. A gas channel 11 is defined both in the buckle tongue 2 and in the buckle 10 and communicates with the airbag cushion 7. The gas channel 11 is connected to the inflator 8 so that, when the inflator 8 is operated and caused to explode, airbag gas generated by the inflator 8 can be supplied to the airbag cushion 7 through both the buckle 10 and the buckle tongue 2.

Further, the part of the airbag cushion 7, which passes through the shoulder belt 4 and is connected to the buckle tongue 2, is covered with a cushion cover 12.

However, the conventional air belt apparatus having the above-mentioned construction is problematic in that, because the airbag cushion 7 is embedded in the shoulder belt 4, the thickness of the shoulder belt 4 is increased, so that, when the shoulder belt 4 is retracted into the shoulder belt retractor 3, the shoulder belt 4 may not pass through the belt hook 1.

Therefore, in an effort to overcome the problem in which the shoulder belt 4 may not pass through the belt hook 1, the conventional air belt apparatus requires that the lap belt retractor 5 be used to retract the lap belt 6. However, the addition of the lap belt retractor 5 to the air belt apparatus increases the weight and production cost of the apparatus and causes there to be a shortage of space when installing the apparatus in the vehicle.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an air belt apparatus for a vehicle, which is constructed using one seat belt for holding and protecting a passenger sitting in a seat and one belt retractor for retracting the seat belt, thus reducing the number of parts of the apparatus and thereby reducing the weight and production cost of the apparatus and solving the space-related problem that occurs in the installation of the apparatus in the vehicle.

In an aspect of the present invention, the air belt apparatus for a vehicle, may include a seat belt passing through a belt hook mounted to a vehicle body and through a buckle tongue, with a first end of the seat belt being coupled to a belt retractor mounted to the vehicle body in such a way that the seat belt may be released from or retracted into the belt retractor, and with a second end of the seat belt being fixed to the vehicle body, and an airbag cushion which covers the seat belt and may be mounted at one end thereof to the buckle tongue, wherein the seat belt may be slidably mounted to the airbag cushion such that the airbag cushion does not move along with the seat belt, and wherein the airbag cushion may be fluid-connected to the buckle tongue and receives airbag gas through the buckle tongue.

The air belt apparatus for the vehicle may include a cushion cover which covers the airbag cushion and may be mounted at one end thereof to the buckle tongue.

The air belt apparatus may further include a buckle mounted to the vehicle body wherein the buckle tongue may be detachably fastened to the buckle, and when the buckle tongue may be fastened to the buckle, the buckle cooperates with the buckle tongue and forms a gas channel communicating with the airbag cushion through the buckle and the buckle tongue, an inflator provided for generating airbag gas to supply the airbag gas to the airbag cushion through the gas channel, and an airbag control unit provided for controlling operation of the inflator.

The second end of the seat belt may be fixed to the vehicle body using an anchor.

The airbag cushion may be provided on the seat belt between the belt hook and the buckle tongue.

The airbag cushion may be provided with a belt moving channel to slidably receive the seat belt therein for allowing the seat belt to be movable along the airbag cushion in an axial direction thereof.

The belt moving channel may be configured such that a first end thereof directed toward the belt hook may be open, while a second end thereof directed toward the buckle tongue may be closed, with a belt passing hole being formed in the closed second end of the belt moving channel and through which the seat belt may be slidably passed.

The belt moving channel may be formed in the airbag cushion by sewing work performed to produce the airbag cushion.

The seat belt may be slidably mounted to the airbag cushion through the belt moving channel formed through a portion of the buckle tongue.

As described above, the air bag apparatus for the vehicle according to the present invention is advantageous in that the air belt apparatus is constructed using one seat belt to hold and protect a passenger sitting in a seat and using one belt retractor to release and retract the seat belt, thus reducing the number of parts of the apparatus and thereby reducing the weight and production cost of the apparatus and solving the space-related problem occurring in the installation of the apparatus in the vehicle.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view of a conventional air belt apparatus for a vehicle.

FIG. 2 and FIG. 3 are sectional views taken along lines I-I and II-II of FIG. 1.

FIG. 4 is a perspective view of an air belt apparatus for a vehicle according to an exemplary embodiment of the present invention.

FIG. 5 and FIG. 6 are sectional views taken along lines III-III and IV-IV of FIG. 4.

FIG. 7 is a development view showing an airbag cushion through which a seat belt passes.

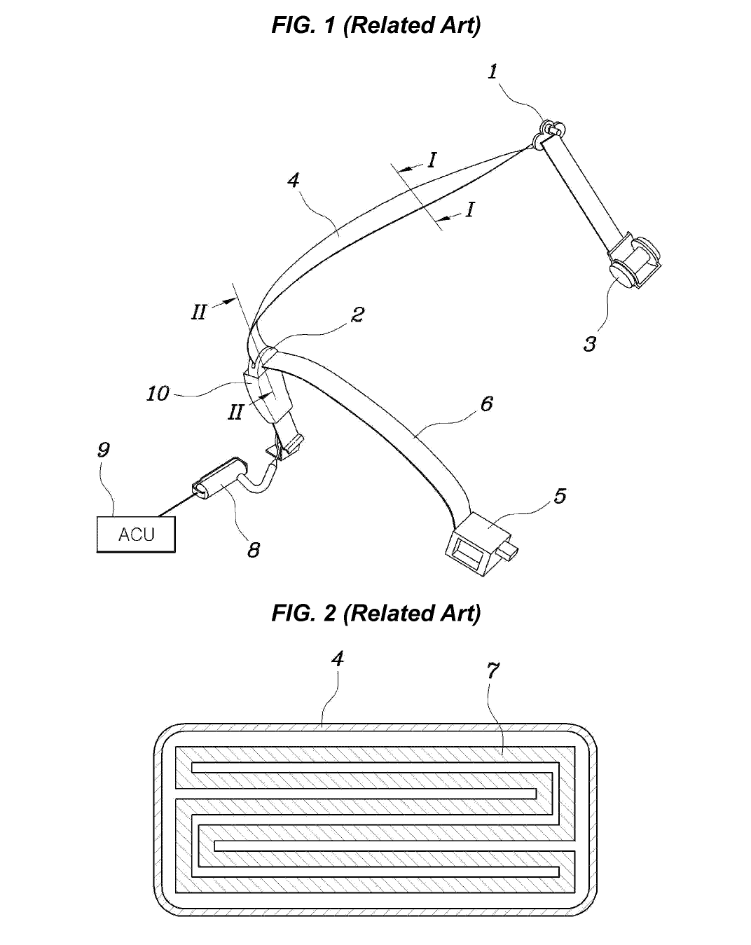

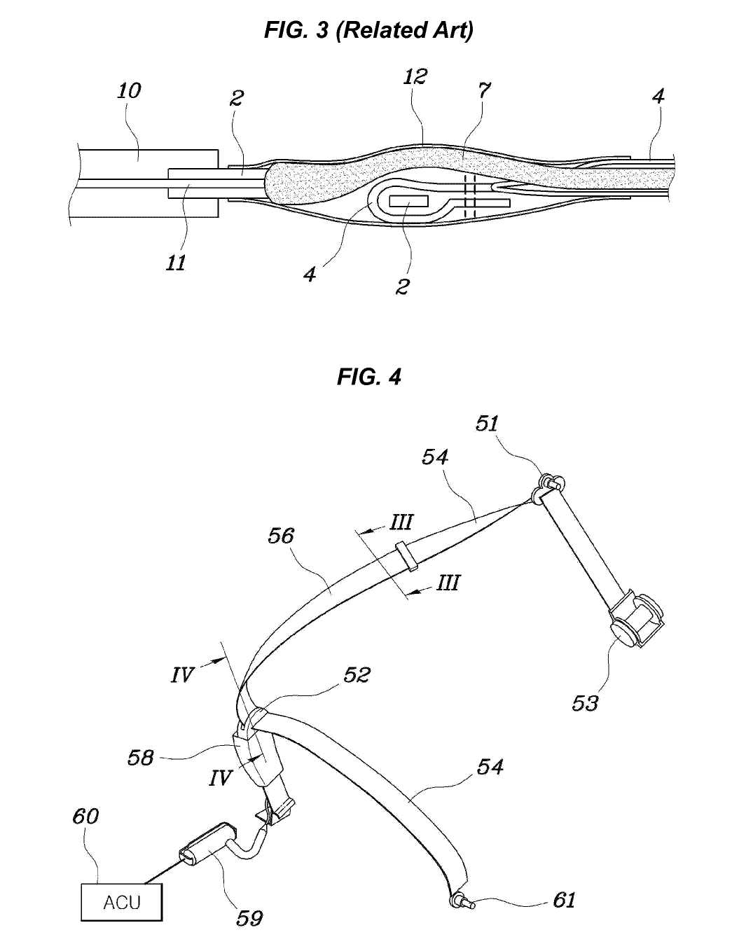

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Reference will now be made in greater detail to a preferred embodiment of the invention with reference to the accompanying drawings.

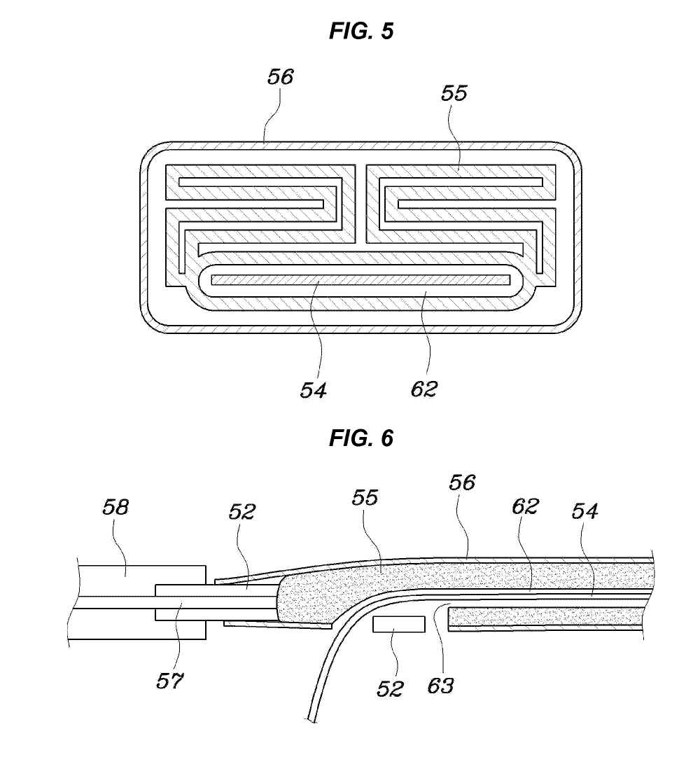

As shown in FIG. 4 through FIG. 7, an air belt apparatus for a vehicle according to an exemplary embodiment of the present invention includes a seat belt 54, which sequentially passes through a belt hook 51 mounted to a vehicle body and through a buckle tongue 52, and of which a first end is coupled to a belt retractor 53 mounted to the vehicle body in such a way that the belt 54 can be released from or retracted into the belt retractor 53, and a second end is fixed to the vehicle body. The air belt apparatus further includes an airbag cushion 55, which has a structure covering the seat belt 54. The airbag cushion 55 covers the seat belt 54 in such a way that the cushion 55 is not moved along with the seat belt 54, and is mounted at one end thereof to the buckle tongue 52 such that it can receive airbag gas through the buckle tongue 52. The air belt apparatus further includes a cushion cover 56, which covers the airbag cushion 55 and is mounted at one end thereof to the buckle tongue 52. Further, a buckle 58 is mounted to the vehicle body in such a way that the buckle tongue 52 can be detachably fastened to the buckle 58. When the buckle tongue 52 is fastened to the buckle 58, the buckle 58 cooperates with the buckle tongue 52 so as to form a gas channel 57 that communicates with the airbag cushion 55. The air belt apparatus further includes an inflator 59, which can generate airbag gas so as to supply the airbag gas to the airbag cushion 55 through the gas channel 57, and an airbag control unit 60 provided for controlling the operation of the inflator 59.

Here, the belt hook 51 is installed on an upper end of a center pillar trim such that the belt hook 51 protrudes inside a passenger compartment of a vehicle. Further, the belt retractor 53 is mounted in an inner space of the center pillar trim such that the belt retractor 53 can be fixed to the vehicle body. Therefore, the upper end of the seat belt 54, that is, the first end of the seat belt 54 passes through the belt hook 51 and is inserted into the inner space of the center pillar trim, and is coupled to the belt retractor 53 in such a way that the seat belt 53 can be released from or retracted into the belt retractor 53.

Further, the lower end of the seat belt 54, that is, the second end of the seat belt 54 is fixed to a vehicle floor panel using an anchor 61 after passing through the buckle tongue 52.

The airbag cushion 55 occupies a range between the belt hook 51 and the buckle tongue 52 that is within the entire range of the seat belt 54 and protects the chest of a passenger wearing the seat belt 54.

Further, the airbag cushion 55 is provided with a belt moving channel 62 for allowing the seat belt 54 to be moved along the airbag cushion 55 in an axial direction. The belt moving channel 62 is formed in the airbag cushion 55 by sewing when the airbag cushion 55 is produced.

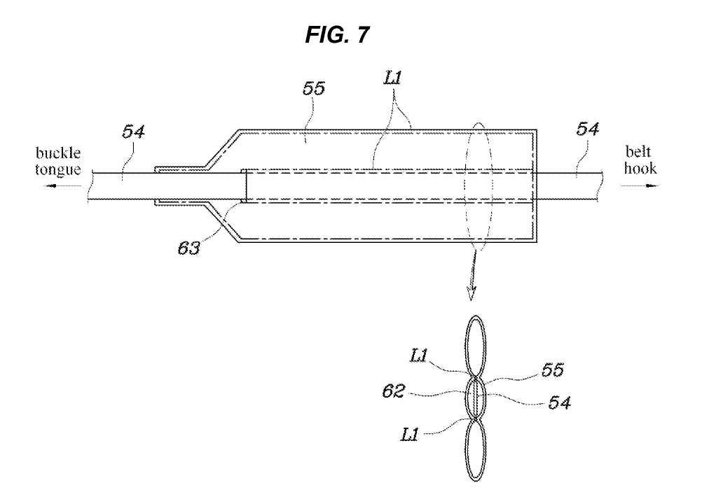

The sewing work is simple work which has been generally used to produce such airbag cushions 55 using a cloth as a material of the cushion. In FIG. 7, the reference character L1 designates sewing lines formed in the airbag cushion by the sewing work.

Here, the belt moving channel 62 is configured such that a first end thereof directed toward the belt hook 51 is open, while a second end thereof directed toward the buckle tongue 52 is closed. The closed second end of the belt moving channel 62 is provided with a belt passing hole 63 through which the seat belt 54 can pass through.

In other words, the second end of the seat belt 54, which has passed through the belt passing hole 63, passes through the buckle tongue 52 and is fixed to the vehicle body using the anchor 61.

As described above, in the air belt apparatus according to an exemplary embodiment of the present invention, the seat belt 54 can freely move through the belt moving channel 62 defined in the airbag cushion 55. Further, when the seat belt 54 is moved through the belt moving channel 62, the airbag cushion 55 is not moved along with movement of the seat belt 54, so that the seat belt 54 can efficiently pass through the belt hook 51 and can be efficiently released from or retracted into the belt retractor 53.

Therefore, the air belt apparatus according to an exemplary embodiment of the present invention can efficiently realize the belt releasing motion and the belt retracting motion using a single belt retractor 53, so that the present invention is advantageous in that it does not require a lap belt retractor used in a conventional air belt apparatus, thereby reducing the number of parts of the air belt apparatus and realizing a reduction in the weight and production cost of the air belt apparatus and solving the space-related problem that occurs when the air belt apparatus is installed in a vehicle.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An air belt apparatus for a vehicle, comprising:
a seat belt passing through a belt hook mounted to a vehicle body and through a buckle tongue, with a first end of the seat belt being coupled to a belt retractor mounted to the vehicle body in such a way that the seat belt is released from or retracted into the belt retractor, and with a second end of the seat belt being fixed to the vehicle body; and
an airbag cushion which covers the seat belt and is mounted at one end thereof to the buckle tongue,
wherein the seat belt is slidably mounted to the airbag cushion such that the airbag cushion does not move along with the seat belt, and
wherein the airbag cushion is fluid-connected to the buckle tongue and receives airbag gas through the buckle tongue.

2. The air belt apparatus for the vehicle as set forth in claim 1, further comprising: a cushion cover which covers the airbag cushion and is mounted at one end thereof to the buckle tongue.

3. The air belt apparatus for the vehicle as set forth in claim 1, further comprising:
a buckle mounted to the vehicle body wherein the buckle tongue is detachably fastened to the buckle, and when the buckle tongue is fastened to the buckle, the buckle cooperates with the buckle tongue and forms a gas channel communicating with the airbag cushion through the buckle and the buckle tongue;
an inflator provided for generating airbag gas to supply the airbag gas to the airbag cushion through the gas channel; and
an airbag control unit provided for controlling operation of the inflator.

4. The air belt apparatus for the vehicle as set forth in claim 1, wherein the second end of the seat belt is fixed to the vehicle body using an anchor.

5. The air belt apparatus for the vehicle as set forth in claim 1, wherein the airbag cushion is provided on the seat belt between the belt hook and the buckle tongue.

6. The air belt apparatus for the vehicle as set forth in claim 1, wherein the airbag cushion is provided with a belt moving channel to slidably receive the seat belt therein for allowing the seat belt to be movable along the airbag cushion in an axial direction thereof.

7. The air belt apparatus for the vehicle as set forth in claim 6, wherein the belt moving channel is configured such that a first end thereof directed toward the belt hook is open, while a second end thereof directed toward the buckle tongue is closed, with a belt passing hole being formed in the closed second end of the belt moving channel and through which the seat belt is slidably passed.

8. The air belt apparatus for the vehicle as set forth in claim 6, wherein the belt moving channel is formed in the airbag cushion by sewing work performed to produce the airbag cushion.

9. The air belt apparatus for the vehicle as set forth in claim 6, wherein the seat belt is slidably mounted to the airbag cushion through the belt moving channel formed through a portion of the buckle tongue.
